(19) United States
(12) Patent Application Publication
(10) Pub. No.: US 2026/0101191 A1
(43) Pub. Date: Apr. 9, 2026

(54) DASHBOARD FOR PRIVATE NETWORK SECURITY DATA

(71) Applicant: T-Mobile USA, Inc., Bellevue, WA (US)

(72) Inventors: Geoffrey Todd Gibson, Ben Wheeler, TX (US); Mark Gregory Clancy, Bellevue, WA (US)

(21) Appl. No.: 18/911,084

(22) Filed: Oct. 9, 2024

(51) Int. Cl. H04W 12/086; H04W 12/126

(52) U.S. Cl. CPC H04W 12/086; H04W 12/126

(57) ABSTRACT

The present invention enhances the security visibility of private network resources within a telecommunications network operated by a mobile network operator (MNO). A private network resource is provided to an entity and network security metrics are determined for multiple hops/links within the private network resource. Device security metrics are also determined for multiple wireless devices connected to the private network resource. The network security metrics indicate the security posture of the multiple hops/links, including at least one intermediate hop between the telecommunications network and an endpoint where the entity receives wireless communication data. The device security metrics indicate the security posture of the multiple wireless devices. The network security metrics and device security metrics are output on an individual basis to the entity via a dashboard on a user interface. This allows the entity to view respective security metrics associated with each hop/link and each wireless device.

### BACKGROUND

Organizations are increasingly adopting private networks to provide greater connectivity between their devices and ensure that their sensitive data and communications are shielded from the vulnerabilities associated with public networks. Mobile network operators (MNOs) provide telecommunications networks that can be used to provide private network resources. For example, an MNO can deploy private telecommunications networks for an entity to enable that entity’s wireless devices to access dedicated network resources that are unavailable to the MNO’s public customers. Similarly, the MNO can provide a private network slice of the MNO’s telecommunications network to the entity to handle network traffic from the entity. Given that these private networks are used to communicate data from the entity, the entity is concerned with the security of the private telecommunications network provided by the MNO. In general, however, the entity is only provided paper attestations about the security of the network. Accordingly, entities receiving private network resources may be skeptical about the security of their data, which can create hesitancy to implement these private networks.

### BRIEF DESCRIPTION OF THE DRAWINGS

Detailed descriptions of implementations of the present invention will be described and explained through the use of the accompanying drawings.

FIG. 1 illustrates a wireless communications system that can implement aspects of the present technology.

FIG. 2 illustrates 5G core network functions (NFs) that can implement aspects of the present technology.

FIG. 3 illustrates an example method for displaying network security metrics in accordance with aspects of the present technology.

FIG. 4 illustrates an example method for displaying device security metrics in accordance with aspects of the present technology.

FIG. 5 illustrates an example computer system in which at least some aspects of the present technology can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

MNOs can provide enterprise or government customers with private telecommunications network services to provide these customers with secure, reliable, and high-performance connectivity solutions that are tailored to their specific requirements. Private network resources utilize dedicated spectrum, hardware, and software resources that are not shared with public users, ensuring optimal performance and minimal interference. For example, an MNO can provide a private network to a customer to enable the customer’s devices to communicate through access nodes and a network core that is inaccessible to the MNO’s public customers. Similarly, the MNO can slice its telecommunications network into individual slices that can be used to handle traffic from the customers’ devices and to which the MNO’s public customers can be restricted access. Given that elements of these private network resources can be implemented by the MNO rather than by the customers themselves, customers may be blind to the functionality that takes place within the portions of the private network resource that are managed by the MNO.

Instead, the customer may only have visibility at an endpoint of the portion of the private network resource managed by the MNO. For example, in the case of network slicing, the MNO can create private slices of a telecommunications network accessible to its general customers and allocate these private slices to specific traffic from the private customer. Given that the operations to handle the private customer’s traffic are taking place within the MNO’s network (e.g., in the private network slice), the customer does not have the capability to monitor the configuration and security posture of the private network slice. Instead, the customer is provided visibility to the data that is delivered through the network slice at an endpoint. Nonetheless, the intermediate nodes of the private network slice are still used to communicate the customer’s sensitive data, and thus, the customer is concerned about the security of the intermediate nodes of the private network slice. A customer similarly lacks visibility to any portions of private telecommunications networks managed by the MNO (e.g., a network core, radio access nodes, edge compute resources, or NFs), which handle the customer’s sensitive data communicated through the private telecommunications network. For the customer to determine the configuration or security posture of these hidden intermediate nodes, for example, to ensure that the portion of the private network resource is secure, the customer must rely on paper attestations from the MNO. These paper attestations can be unreliable, however, and may not be updated for real-time or near real-time changes to the private network resource. Accordingly, customers may be hesitant to trust the security of the private network resource.

To address this problem and others, the present technology provides a mechanism for providing security data about a private network resource to an entity to which the private network resource is provided. The present technology relates to a dashboard of a user interface for presenting security data about the private network resource to the entity to provide the entity with information about the security posture of the private network resource. The dashboard can display security data about portions of the private network resource managed by the MNO. For example, the MNO can perform vulnerability scans and other security tests to determine security data about the private network resource. The dashboard can display the results of security tests of the intermediate nodes/links of the portion of the private network resource managed by the MNO. The dashboard can further include information about the configurations of intermediate nodes/links of the portion of the private network resource.

The MNO can further utilize its testing systems and connectivity to the wireless devices of the entity connected to the private network resource to perform vulnerability scans and other security tests to determine security data about the wireless devices. In aspects, the MNO can have a variety of testing systems that enable large amounts of security data to be determined. For example, the MNO can engage in vulnerability scans, penetration testing, and other security tests to determine security information about network devices and the wireless devices connected to those networks. Given that the MNO provides the private network resource to which the entity’s wireless devices are coupled, the MNO can test the wireless devices through the private network resource (e.g., directly through a network backend). Thus, this device testing can be more secure and effective than other device testing systems, which require the devices to connect to and exchange data with the MNO or another testing service over the Internet or require the entity to purchase separate testing equipment that can be directly coupled with the wireless devices.

The dashboard can present the information to the entity on an individual basis by determining data related to each node/link or wireless device and presenting this data on the dashboard in association with each node/link. For example, the dashboard can display common vulnerability scoring system (CVSS) scores, key risk indicators (KRIs), or key performance indicators (KPIs) for the individual nodes/links or wireless devices on the dashboard next to or under a dropdown associated with each of the nodes/links or devices. In some cases, the MNO can determine security risk levels associated with the nodes/links or devices based on the security data and display an indication of these security risk levels on the dashboard. For example, the individual nodes can be color-coded based on the various security risk levels such that each of the nodes/links or wireless devices is displayed with a color that corresponds to a different security risk level. In yet other aspects, the dashboard can display specific data about a security configuration of the private network resource or the wireless devices. For example, the dashboard can display an encryption algorithm or other security procedure implemented to secure the node/link or wireless device. Thus, the dashboard can provide an entity a wholistic view of the private network resource, including information about portions of the private network resource managed by the MNO and the entity’s wireless devices connected to the private network resource.

The dashboard can further integrate with the entity’s security information and event management (SIEM) system or security operations center (SOC) to enable the SIEM system or SOC of the entity to manage security events and initiate service to the private network resource or the wireless devices based on the security data. For example, the SIEM system or SOC can determine that there is a security vulnerability at a node/link of the private network resource or a wireless device coupled with the private network resource and initiate a process to perform a service (e.g., a physical service or an over-the-air update) at the node/link or wireless device. In some cases, the update may be scheduled or take place over multiple points in time. The SIEM system or SOC can maintain the status of an update, such as what services have been or are to be performed, when these services are to be performed, and so on. Thus, by interfacing with the SIEM system or SOC, the dashboard can indicate the status of service performed or to be performed at a node/link of the private network resource or a wireless device coupled with the private network resource.

The MNO can further provide managed security services to detect security events that may require the private network resource or the entity’s wireless devices to be serviced. For example, an SIEM system or SOC of the MNO can be used to analyze the security data of the private network resource or the entity’s wireless devices to determine if a vulnerability is present. If so, the SIEM system or SOC of the MNO can communicate an indication of the security event to the entity (e.g., to an SIEM system or SOC of the entity), which can initiate service to remove the vulnerability. Alternatively or additionally, the MNO can manage service and repair to the private network resource or the entity’s wireless devices. Thus, the SIEM system or SOC of the MNO can initiate service to remove the vulnerability.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

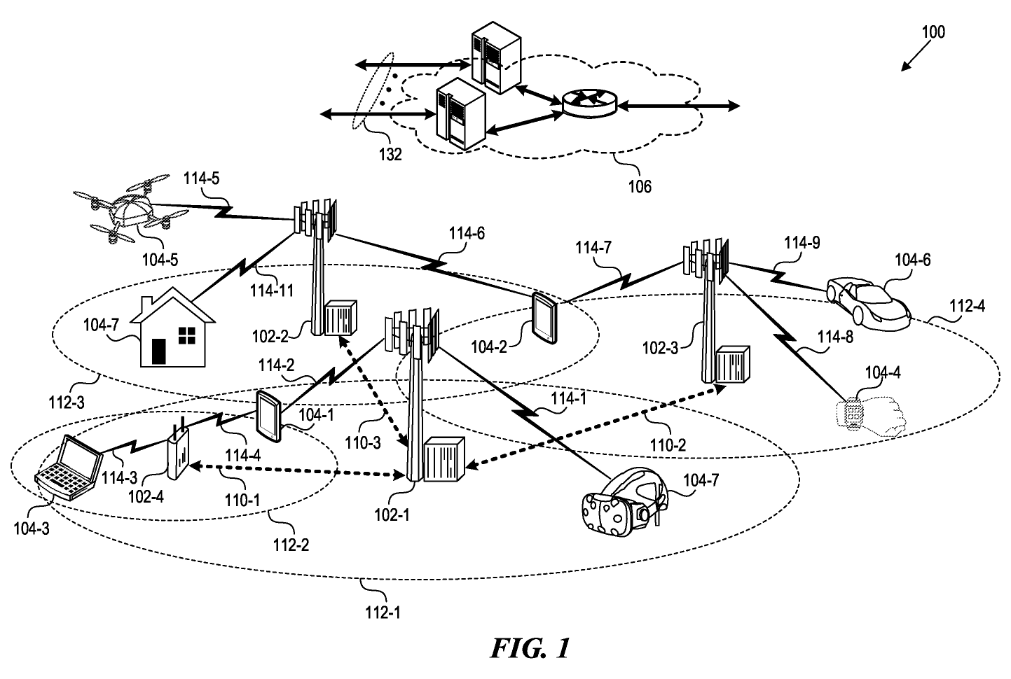

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a communication channel can use any licensed frequency band, any unlicensed band, or a lightly licensed frequency bands. As a non-limiting example, a 5G communication channel can use millimeter wave (mmW) access frequencies of 28 gigahertz (GHz) or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid Automatic Repeat Request (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of the network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 5G or 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage. These features can similarly be implemented through 5G or other wireless technologies.

### 5G Core NFs

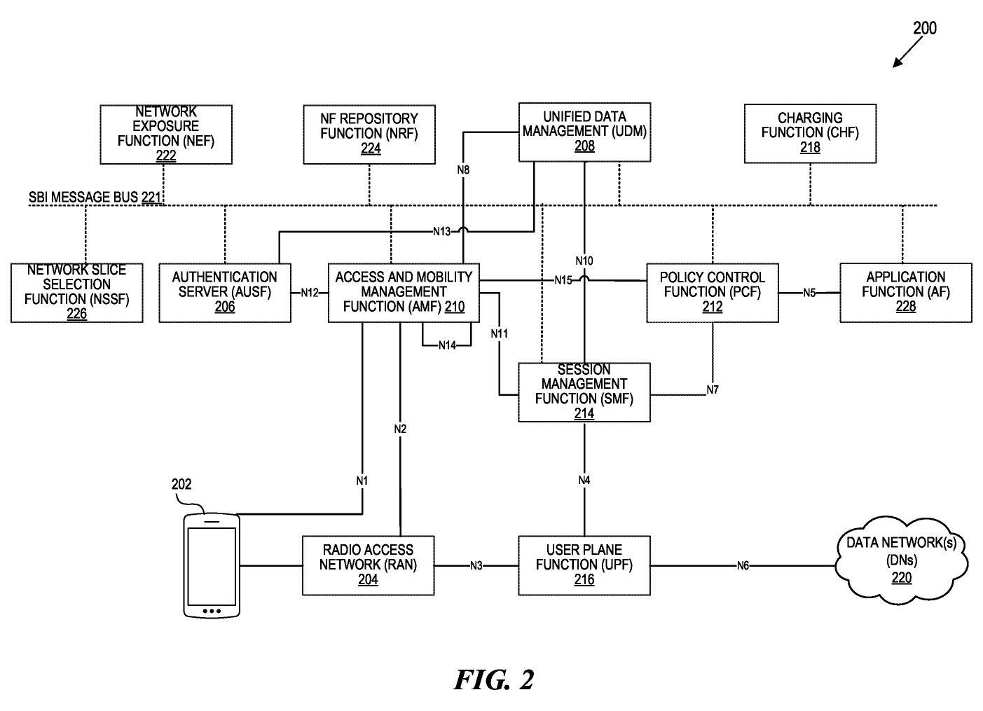

FIG. 2 illustrates 5G core NFs 200 that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### DASHBOARD FOR PRIVATE NETWORK SECURITY DATA

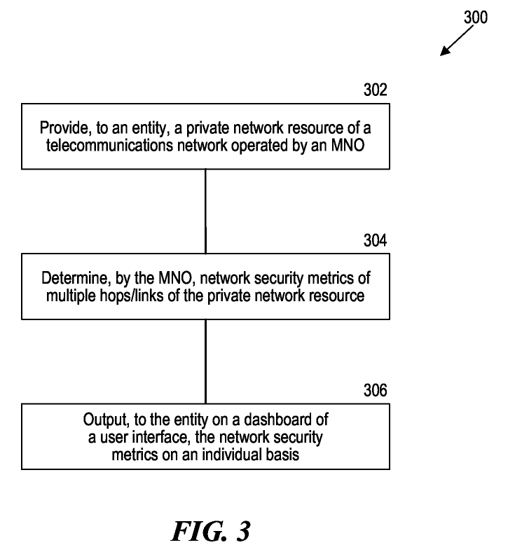

FIG. 3 illustrates an example method 300 for displaying network security metrics in accordance with aspects of the present technology. Although illustrated in a particular configuration, one or more operations of the method 300 may be omitted, repeated, or reorganized. Additionally, the method 300 may include other operations not illustrated in FIG. 3—for example, operations detailed in one or more other methods described herein.

At 302, a private network resource of a telecommunications network operated by an MNO is provided to an entity. For example, the MNO can provide an enterprise or government customers with private telecommunications network services to offer secure, reliable, and high-performance connectivity solutions tailored to specific requirements. These private network resources utilize dedicated spectrum, hardware, and software resources that are not shared with public users, ensuring optimal performance and minimal interference. For instance, an MNO can provide a private telecommunications network (e.g., private 4G, LTE, 5G, 6G, or other network) to the entity, enabling the entity’s wireless devices (e.g., smartphones, tablets, laptops, IoT devices, drones, and other wireless devices) to communicate through access nodes or a network core that is inaccessible to the MNO’s public customers. Similarly, the MNO can slice its telecommunications network into individual slices to handle traffic from the entity’s devices, restricting access to the MNO’s public customers.

Elements of these private network resources can be implemented by the MNO rather than the entity. For example, in the case of a private telecommunications network, the network core, network access nodes, NFs, or any other portion of the network can be provided or managed by the MNO. Thus, the entity receiving the private network resource may be blind to the actual operations that take place at intermediate nodes within the portion of the private network resource managed by the MNO (e.g., the security algorithms, switches, gateways, or other network configurations within a network core, radio access nodes, edge compute resources, or NFs). Instead, the entity may only see data communicated at an endpoint of these portions, such as the data output from the network core, radio access nodes, and so on.

Similar to providing a private telecommunications network, the operations within intermediate nodes of a private network slice are likely controlled by the MNO, and the entity receiving the private network resource may be blind to the functionality within these portions. For example, the MNO can create private slices of a telecommunications network accessible to its general customers and allocate these private slices to specific traffic from the private entity. Given that the operations to handle the private entity’s traffic occur within the MNO’s network (e.g., in the private network slice), the entity does not have the capability to monitor the configuration and security posture of the private network slice. Instead, the entity may typically have visibility at an endpoint of the private network slice, for example, when data (e.g., on the user plane) is returned from or provided to the private network slice. Nonetheless, the intermediate nodes of the private network slice within the MNO’s telecommunications network are still used to communicate the entity’s sensitive data, and thus, the entity is concerned about the security of these nodes.

Similar issues also exist for other private network resources, such as fixed-wireless access or fiber to the premises. For example, entities provided private fixed-wireless access resources may be unaware of the operations or security of nodes or functions within the network. Similarly, fiber-to-the-premises customers may only be aware of the data entering or exiting at the endpoints of the fiber optic cable but blind to the operations occurring to communicate data to/from the premises. In general, for the entity provided these private network resources to determine the configuration or security posture of hidden intermediate nodes, for example, to ensure that the portion of the private network resource is secure, the customer must rely on paper attestations from the MNO. These paper attestations can be unreliable and may not be updated for real-time or near real-time changes to the private network resource. Accordingly, customers may be hesitant to trust the security of the private network resource.

At 304, the MNO determines network security metrics of multiple hops/links of the private network resource. The network security metrics can include security test data indicative of security testing performed on the multiple hops/links. For example, the MNO (e.g., through an SIEM system or SOC of the MNO) can perform vulnerability testing, penetration testing, or any other security testing to determine data relating to the security of individual hops/links of the private network resource. As a specific example, the security testing can be used to determine CVSS scores or KPIs for the individual hops/links of the private network resource. In aspects, the security testing can be used to determine data about an intermediate hop/link in a portion of the private network resource managed by the MNO. In this way, the security testing can be used to determine network security metrics that are not generally visible to the entity to which the private network resource is provided.

The network security metrics can further include network configuration data indicative of a security procedure used to secure the multiple hops/links of the private network resource. The network configuration data can include the specific protocols or security procedures performed at each hop/link of the private network resource. For example, the network configuration data can include the specific confidentiality or integrity algorithms used to secure a hop/link of the private network resource. As a specific example, the network configuration data can identify a technique (e.g., type of encryption) used to encrypt a particular hop/link of the private network resource. In aspects, the network configuration data can include configuration data about an intermediate hop/link in a portion of the private network resource managed by the MNO. In this way, the network configuration data can provide the entity with greater transparency over the configuration and security of the private network resource.

In some implementations, the network security metrics can be used to identify security risk levels associated with the individual hops/links. The security risk levels can indicate a security risk posed by the hop/link. In some cases, the security risk levels can be determined by an SIEM system or SOC of the MNO based on the network security metrics (e.g., using the CVSS scores, the KPIs, or the network configuration data). In some cases, the network configuration data can be based on the particular network configuration of the hop/link. For example, a hop/link encrypted through a particular technique or running a particular protocol can be a greater security risk than a hop/link having the same security test results (e.g., CVSS scores and KPIs) but implemented in a different configuration (e.g., using a different protocol or encrypted differently). The security risk levels can be determined from a range of security risk levels, including, for example, a low security risk level that requires less protection or is more readily contained, a medium security risk level that requires moderate protection (e.g., more resources), and a high security risk level that requires even more resources to protect the hop/link.

At 306, the MNO outputs the network security metrics to the entity on a dashboard of a user interface. The dashboard can be accessible to the entity through an account accessible to the entity. For example, the dashboard can be presented through the entity’s account with the MNO. The network security metrics can be output on an individual basis such that respective network security metrics of a respective hop/link are output in association with the respective hop/link. For example, the dashboard can display an indication of each hop/link of the private network resource, and CVSS scores or KPIs for the individual hops/links can be displayed on the dashboard next to or under a dropdown associated with each of the hops/links. In some cases, the network security metrics can be displayed in response to an input from the entity to display one or more security metrics.

The dashboard can display specific data about a security configuration of the hops/links of the private network resource. For example, the dashboard can display a confidentiality or integrity algorithm (e.g., encryption algorithm) or other security procedure implemented to secure a particular hop/link in association with that hop/link. Similarly, the protocols or other security features implemented at the hop/link can be displayed on the dashboard in association with the hop/link. The specific information displayed on the dashboard can further be configured by the entity or MNO. For example, the entity or MNO can configure the dashboard to display particular security test data or security configuration data. The dashboard can further update the network security data in real time or near real time to provide greater transparency to the entity about the security posture of the private network resource. For example, in response to new security tests performed on the private network resource or a change to a configuration of the private network resource, the new test data collected from these new security tests or the updated configuration can be displayed on the dashboard.

The dashboard can display an indication of the security risk levels associated with the hops/links. For example, the individual hops/links can be color-coded based on the various security risk levels such that each of the hops/links is displayed with a color that corresponds to a different security risk level. As a specific example, the hops/links having the low security risk level can be displayed as green, those with the medium security risk level can be displayed as yellow, and those with the high security risk level can be displayed as red. In other cases, the hops/links can be displayed as a single color with shade or saturation based on the security risk level.

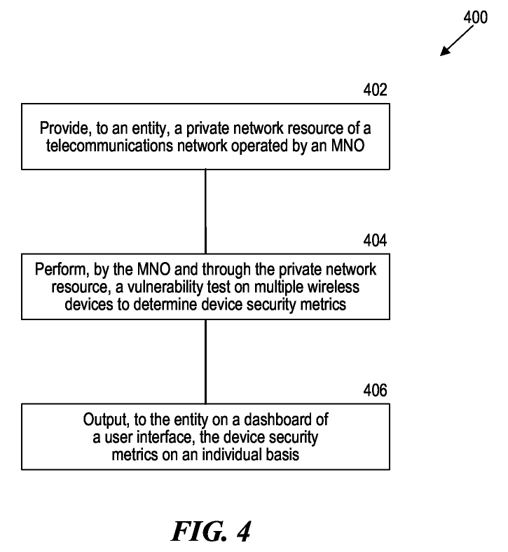

FIG. 4 illustrates an example method 400 for displaying device security metrics in accordance with aspects of the present technology. Although illustrated in a particular configuration, one or more operations of the method 400 may be omitted, repeated, or reorganized. Additionally, the method 400 may include other operations not illustrated in FIG. 4—for example, operations detailed in one or more other methods described herein.

At 402, a private network resource of a telecommunications network operated by an MNO is provided to an entity. The private network resource can be provided similarly to the discussion at 302 with respect to FIG. 3. The entity can deploy wireless devices that connect to the private network resource for connectivity. In aspects, the wireless devices can be managed by the entity. For example, the wireless devices can implement user profiles associated with the entity, and the function or entitlements of the wireless devices can be managed by the entity. In this regard, the entity can be responsible for ensuring the security of the wireless devices. Given that the MNO operates at least a portion of the private network resource to which the wireless devices are connected, however, the MNO can utilize its testing systems to perform vulnerability scans and other security tests using the private network resource to determine security data about the wireless devices.

At 404, the MNO performs a security test on multiple wireless devices connected to the private network resource to determine device security metrics. The security test can be performed through the private network resource, without requiring the communication of device information over the Internet. For example, given that the MNO operates at least a portion of the private network resource, the private network resource can be coupled to backend testing tools of the MNO. Thus, the MNO can perform the security test through the private network resource exclusive of the Internet and without having to connect the wireless devices (e.g., physically or over the air) to separate testing equipment (e.g., provided by the entity or a third-party service). Without this testing, the entity may have to resort to connecting the wireless device to testing equipment procured by the entity, or transmitting device data over the Internet to a third-party service that can provide security testing. Given that the MNO can perform testing using its existing testing equipment and without requiring a connection to the Internet, this testing can be performed cost-effectively and securely.

Moreover, the MNO can include testing equipment that can perform thorough testing at the wireless devices (e.g., on an individual basis). For example, the MNO can perform vulnerability scans, penetration testing, or network trace analysis at the wireless devices. In aspects, the testing can result in device test data, such as CVSS scores or KPIs for the wireless devices. Thus, by performing the device testing through the MNO, security information can be determined more thoroughly and efficiently. The MNO can further determine device configuration data about a security configuration of the wireless devices. The network configuration data can include the specific confidentiality or integrity algorithms used to secure a hop/link of the private network resource. As a specific example, the device configuration data can identify a security procedure (e.g., a confidentiality or integrity algorithm used to secure the device) implemented on the device. The device configuration can be determined from communication with the devices over the private network resource or separate communications with the entity (e.g., through the SIEM system or SOC of the entity).

The MNO can similarly determine a security risk level associated with each of the wireless devices based on the device security metrics. These security risk levels can be determined similarly to the security risk levels of the network elements, as discussed with respect to FIG. 3.

At 406, the MNO outputs the device security metrics to the entity on a dashboard of a user interface. The dashboard can be similar to the dashboard discussed with respect to FIG. 3. Moreover, the MNO can output the device security metrics in addition to the network security metrics, as discussed with respect to FIG. 3, on the same dashboard (e.g., on the same or different pages/windows of the dashboard). In this way, the dashboard can provide a single interface for viewing the security posture of the private network resource and the device connected thereto.

The device security metrics can be output on an individual basis such that respective device security metrics of a respective device are output in association with the respective device. For example, the dashboard can display an indication of each device of the private network resource, and CVSS scores or KPIs for the individual devices can be displayed on the dashboard next to or under a dropdown associated with each of the devices. In some cases, the device security metrics can be displayed in response to an input from the entity to display one or more security metrics. The dashboard can display specific data about a security configuration of the devices of the private network resource. For example, the dashboard can display configuration data similar to that discussed with respect to FIG. 3 for the hops/links. The dashboard can similarly display an indication of the security risk levels associated with the wireless devices (e.g., by color-coding the indications of the wireless devices displayed in the dashboard).

The dashboard or SIEM system or SOC of the MNO can further integrate with the entity’s SIEM system or SOC to enable the SIEM system or SOC of the entity to manage security events and initiate service to the hops/links or devices based on the security data (e.g., including the network security metrics discussed with respect to FIG. 3 and the device security metrics discussed with respect to FIG. 4). For example, the SIEM system or SOC of the entity can determine that there is a security vulnerability at a hop/link of the private network resource or a wireless device coupled with the private network resource and initiate a process to perform a service (e.g., a physical service or an over-the-air update) at the hop/link or wireless device. The SIEM system or SOC can maintain the status of an update, such as what services have been or are to be performed, when these services are to be performed, and so on. The status of the service can be displayed on the dashboard in association with the particular hop/link at which the service is or is to be performed. In this way, the dashboard can be used to keep the entity informed about the status of the private network resource in real time or near real time.

The MNO can further provide managed security services to detect security events that may require the private network resource or the entity’s wireless devices to be serviced. For example, an SIEM system or SOC of the MNO can be used to analyze the security data of the private network resource or the entity’s wireless devices to determine if a vulnerability is present. If so, the SIEM system or SOC of the MNO can communicate an indication of the security event to the entity (e.g., to an SIEM system or SOC of the entity), which can initiate service to remove the vulnerability. Alternatively or additionally, the MNO can manage service and repair to the private network resource or the entity’s wireless devices. Thus, the SIEM system or SOC of the MNO can initiate service to remove the vulnerability and display the status of this service on the dashboard.

### Computer System

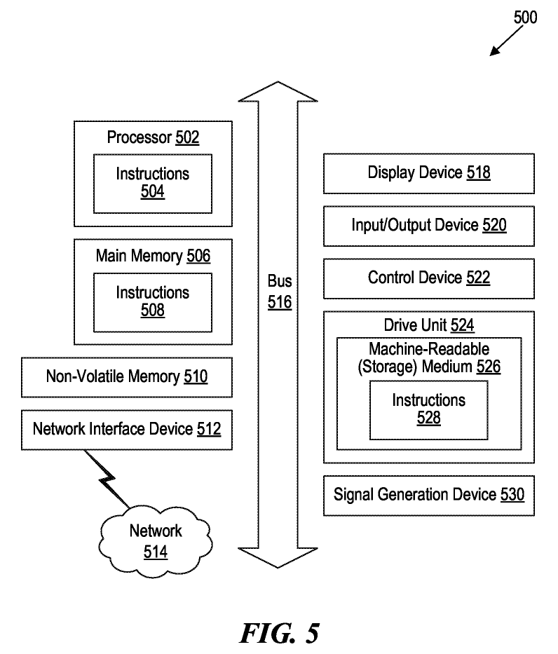

FIG. 5 is a block diagram that illustrates an example of a computing system 500 in which at least some operations described herein can be implemented. As shown, the computing system 500 can include one or more processors 502, main memory 506, non-volatile memory 510, a network interface device 512, a display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computing system 500 is intended to illustrate a hardware device on which components illustrated or described relative to the examples of the figures and any other components described in this specification can be implemented.

The computing system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR system (e.g., head-mounted display), or any electronic device capable of executing a set of instructions that specifies action(s) to be taken by the computing system 500. In some implementations, the computing system 500 can be an embedded computing system, a system-on-chip, a single-board computing (SBC) system, or a distributed system such as a mesh of computing systems, or it can include one or more cloud components in one or more networks. Where appropriate, one or more computing systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable (storage) medium 526) can be local, remote, or distributed. Although shown as a single medium, the machine-readable (storage) medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable (storage) medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A method comprising:
providing, to an entity, a private network resource of a telecommunications network operated by a mobile network operator (MNO);
determining, by the MNO, network security metrics of multiple hops of the private network resource, the network security metrics indicating a security posture of the multiple hops,
wherein the multiple hops include at least one intermediate hop of a portion of the private network resource managed by the MNO,
wherein data communicated by the intermediate hop is not directly visible to the entity;
determining, by the MNO, device security metrics of multiple wireless devices connected to the private network resource, the device security metrics indicating a security posture of the multiple wireless devices;
in response to determining the network security metrics, outputting, to the entity on a dashboard of a user interface, the network security metrics on a hop-by-hop basis such that respective network security metrics of a respective hop are output in association with the respective hop; and
in response to determining the device security metrics, outputting, to the entity on the dashboard of the user interface, the device security metrics on a device-by-device basis such that respective device security metrics of a respective wireless device are output in association with the respective wireless device.

2. The method of claim 1, wherein the private network resource comprises a private telecommunications network.

3. The method of claim 1, wherein the private network resource comprises an end-to-end network slice of the telecommunications network.

4. The method of claim 1, further comprising:
determining security risk levels of the multiple hops based on the network security metrics; and
outputting, to the entity on the dashboard of the user interface, a color-coded depiction of the multiple hops based on the security risk levels,
wherein each color of the color-coded depiction is associated with a different one of the security risk levels.

5. The method of claim 1, wherein:
the network security metrics comprise key performance indicators (KPIs) of the multiple hops; or
the device security metrics comprise KPIs of the multiple wireless devices.

6. The method of claim 1, wherein:
the network security metrics comprise common vulnerability scoring system (CVSS) scores of the multiple hops; or
the device security metrics comprise CVSS scores of the multiple wireless devices.

7. The method of claim 1, wherein:
the network security metrics comprise a confidentiality or integrity algorithm utilized to secure at least one hop of the multiple hops; and
outputting the network security metrics on the hop-by-hop basis comprises outputting, to the entity on the dashboard of the user interface, an indication of the confidentiality or integrity algorithm in association with the at least one hop.

8. The method of claim 1, further comprising:
determining, by a security information and event management (SIEM) system or security operations center (SOC) of the MNO, a security event associated with at least one of the multiple hops or at least one of the multiple wireless devices based on the network security metrics or the device security metrics,
wherein the security event indicates that service is needed at the at least one of the multiple hops or the at least one of the multiple wireless devices; and
transmitting, from the SIEM system or the SOC of the MNO to an SIEM system or SOC of the entity, an indication of the security event associated with the at least one of the multiple hops or the at least one of the multiple wireless devices.

9. The method of claim 1, further comprising:
receiving, from a security information and event management (SIEM) system or security operations center (SOC) of the MNO, network repair data related to a status of service performed at or scheduled for performance at at least one of the multiple hops or at least one of the multiple wireless devices; and
in response to receiving the network repair data, outputting, to the entity on the dashboard of the user interface, the status of the service performed at or scheduled for performance at at least one of the multiple hops or at least one of the multiple wireless devices in association with the at least one of the multiple hops or the at least one of the multiple wireless devices.

10. A system comprising:
at least one hardware processor; and
at least one non-transitory, computer-readable storage medium storing instructions, which, when executed by the at least one hardware processor, cause the system to:
provide, to an entity, a private network resource of a telecommunications network operated by a mobile network operator (MNO);
determine, by the MNO, network security metrics of multiple hops of the private network resource or multiple communication links between the multiple hops,
wherein the network security metrics include:
security configuration data indicative of a security procedure used to secure the multiple hops or multiple communication links between the multiple hops; and
security test data indicative of vulnerability testing performed on the multiple hops or the multiple communication links, and
wherein the multiple hops include at least one intermediate hop of the private network resource; and
in response to determining the network security metrics, output, to the entity on a dashboard of a user interface, the network security metrics on an individual basis such that respective network security metrics of a respective hop or communication link are output in association with the respective hop or communication link.

11. The system of claim 10, wherein the private network resource comprises a private telecommunications network.

12. The system of claim 10, wherein the private network resource comprises an end-to-end network slice of the telecommunications network.

13. The system of claim 10, wherein the system is further caused to:
determine security risk levels of the multiple hops or the multiple communication links based on the security test data; and
output, to the entity on the dashboard of the user interface, a color-coded depiction of the multiple hops based on the security risk levels,
wherein each color of the color-coded depiction is associated with a different one of the security risk levels.

14. The system of claim 10, wherein the security test data comprise common vulnerability scoring system (CVSS) scores of the multiple hops or the multiple communication links.

15. The system of claim 10, wherein:
the network security metrics comprise an encryption algorithm utilized to secure at least one hop of the multiple hops or at least one communication link of the multiple communication links; and
outputting the network security metrics on the individual basis comprises outputting, to the entity on the dashboard of the user interface, an indication of the encryption algorithm in association with the at least one hop or the at least one communication link.

16. The system of claim 10, wherein the system is further caused to:
determine, by a security information and event management (SIEM) system or security operations center (SOC) of the MNO, a security event associated with at least one of the multiple hops or at least one of the multiple communication links based on the security test data,
wherein the security event indicates that service is needed at the at least one of the multiple hops or the at least one of the multiple communication links; and
transmit, from the SIEM system or the SOC of the MNO to an SIEM system or SOC of the entity, an indication of the security event associated with the at least one of the multiple hops or the at least one of the multiple communication links.

17. At least one non-transitory, computer-readable storage medium storing instructions, which, when executed by at least one data processor of a system, cause the system to:
provide, to an entity, a private network resource of a telecommunications network operated by a mobile network operator (MNO);
perform, by the MNO, through the private network resource, and exclusive of Internet communication, a vulnerability test on multiple wireless devices connected to the private network resource;
determine, by the MNO and based on the vulnerability test, device security metrics indicative of the vulnerability test performed on the multiple wireless devices; and
in response to determining the device security metrics, output, to the entity on a dashboard of a user interface, the device security metrics on a device-by-device basis such that respective device security metrics indicative of the vulnerability test performed on a respective wireless device are output in association with the wireless device.

18. The at least one non-transitory, computer-readable storage medium of claim 17, wherein the private network resource comprises a private telecommunications network or an end-to-end network slice of the telecommunications network.

19. The at least one non-transitory, computer-readable storage medium of claim 17, wherein the system is further caused to:
determine security risk levels of the multiple wireless devices based on the device security metrics; and
output, to the entity on the dashboard of the user interface, a color-coded depiction of the multiple wireless devices based on the device security metrics,
wherein each color of the color-coded depiction is associated with a different one of the security risk levels.

20. The at least one non-transitory, computer-readable storage medium of claim 17, wherein the system is further caused to:
receive, from a security information and event management (SIEM) system or security operations center (SOC) of the MNO or an SIEM system or SOC of the entity, network repair data related to a status of service performed at or scheduled for performance at at least one of the multiple wireless devices; and
in response to receiving the network repair data, output, to the entity on the dashboard of the user interface, the status of the service performed at or scheduled for performance at at least one of the multiple wireless devices in association with the at least one of the multiple wireless devices.
